(19) United States
(12) Patent Application Publication
(10) Pub. No.: US 2004/0248039 A1
(43) Pub. Date: Dec. 9, 2004

(54) Photoresist compositions and processes for preparing the same

(76) Inventors: James R. Sounik, Corpus Christi, TX (US); Frank Leonard Schadt III, Wilmington, DE (US); Michael Fryd, Philadelphia, PA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/841,387

(22) Filed: May 7, 2004

Related U.S. Application Data
(60) Provisional application No. 60/468,774, filed on May 8, 2003.

(51) Int. Cl. G03C 1/76

(52) U.S. Cl. 430/281.1

(57) ABSTRACT

The present invention provides novel photoresist compositions and processes for preparing the same utilizing low polydispersity (co)polymers prepared via the polymerization of selected monomers in the presence of RAFT chain transfer agents. The polymers can be homopolymers of substituted styrenes, or can be copolymers comprising additional monomers. These (co)polymers can be converted into photoresist compositions for use as such.

### BACKGROUND OF THE INVENTION

1. Field of the Invention

The present invention relates to novel photoresist compositions and processes for preparing the same utilizing low polydispersity (co)polymers prepared via the polymerization of selected monomers in the presence of RAFT chain transfer agents. The polymers can be homopolymers of substituted styrenes, or can be copolymers comprising additional monomers. These (co)polymers can be converted into photoresist compositions for use as such.

2. Description of the Prior Art

U.S. Pat. No. 5,625,020 relates to a photosensitive resist composition comprising (i) a photosensitive acid generator and (ii) a polymer comprising hydroxystyrene and acrylate, methacrylate or a mixture of acrylate and methacrylate. The resist has high lithographic sensitivity and high thermal stability. However, the process of preparing the polymer as outlined in column 3, lines 10-30 and in Example 1 (of U.S. Pat. No. 5,625,020) results in poor conversion rates and chemical cleavage of some groups in the repeat units.

U.S. Pat. No. 4,898,916 discloses a process for the preparation of poly(vinylphenol) from poly(acetoxystyrene) by acid catalyzed transesterification.

EP 0813113 Al, Barclay, discloses aqueous transesterification to deprotect the protected polymer.

WO 94 14858 A discloses polymerizing hydroxystyrene without protecting groups.

WO 98 01478 and WO 99 31144 disclose the use of chain transfer agents to control the polydispersity of certain polymers.

Other patents of interest include U.S. Pat. Nos. 4,679,843; 4,822,862; 4,912,173; 4,962,147; 5,087,772; 5,239,015; 5,625,007; 5,304,610; 5,789,522; 5,939,511; and 5,945,251.

All of the references described herein are incorporated herein by reference in their entirety.

### SUMMARY OF THE INVENTION

One embodiment of the present invention is a process comprising polymerizing a substituted styrene monomer alone or in combination with one or more additional monomers selected from the group consisting of alkyl acrylates and ethylenically unsaturated co-polymerizable monomers in the presence of a solvent, a RAFT chain transfer agent and an initiator, to form a substituted styrene (co)polymer.

Other embodiments of this invention include substituted styrene (co)polymers produced by the processes of this invention and photoresists derived from these (co)polymers.

### DETAILED DESCRIPTION OF THE INVENTION

This invention relates to a novel, cost-efficient process for the preparation of substituted styrene polymers that can be used to prepare (co)polymers of p-hydroxystyrene (PHS) or substituted p-hydroxystyrene (SPHS) alone or in combination with alkyl acrylates (AA) and/or other monomers such as ethylenically unsaturated copolymerizable monomers (EUCM). This process yields a polymer having enhanced purity and a low polydispersity. The term “(co)polymer” refers to polymers or copolymers.

One embodiment of this invention includes the following steps:

(1) Polymerization of a substituted styrene and alone or in combination with AA and/or EUCM in an alcohol solvent in the presence of a RAFT chain transfer agent and a free radical initiator;

(2) Purification of the polymer from step (1) by fractionation with an alcohol solvent;

(3) Transesterification of the product from step (2) in the presence of a catalyst;

(4) Purification of the product from step (3) by another solvent, immiscible with the alcohol solvent, under distillation conditions;

(5) Catalyst removal via ion exchange of the product from step (3); and

(6) A “solvent swap” of the product of step (5) wherein said alcohol solvent is removed and replaced by a photoresist type solvent.

Some preferred embodiments of the products of the process of this invention include substantially pure homopolymers of p-hydroxystyrene (PHS); copolymers of p-hydroxystyrene and tert-butyl acrylate; copolymers of p-hydroxystyrene and styrene; and terpolymers of p-hydroxystyrene, tert-butyl acrylate and styrene. These hydroxyl-containing polymers have a wide variety of applications including use as in preparing photoresists for the microelectronics industry.

Polymerization

In the process of this invention, a substituted styrene monomer either alone or in combination with an alkyl acrylate and/or one or more copolymerizable monomers (EUCM), is subjected to suitable polymerization conditions in the presence of a solvent, a RAFT chain transfer agent, and an initiator at suitable temperature for a sufficient period of time to produce a (co)polymer of corresponding composition. This process is useful for producing homopolymers derived from the substituted styrenes, as well as copolymers derived from substituted styrenes and one or more other acrylate and/or ethylenically unsaturated copolymerizable monomers.

Suitable substituted styrenes of this invention are represented by compositions of Formula I,

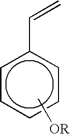

wherein R is R¹ or C(O)R²; and

R¹ and R² are independently H, C₁-C₅ alkyl, either straight chain or branched; and the aromatic ring may be further substituted with functional groups such as halo, alkyl, substituted alkyl, aryl and substituted aryl groups.

Suitable substituted styrenes also include compositions represented by Formula II

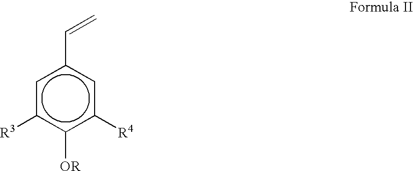

wherein R is described as above; and

R³ and R⁴ are the same or different and independently selected from the group consisting of:

hydrogen; fluorine; chlorine; bromine; phenyl; tolyl; and an alkyl or fluoroalkyl group having the formula CₙHₓF_{y} where n is an integer from 1 to 4, x and y are integers from 0 to 2n+1, and the sum of x and y is 2n+1.

Suitable acrylates are represented by Formula III

H₂C═C(R⁵)C(O)OR⁶ Formula III

wherein

R⁵ is selected from the group consisting of hydrogen, methyl, ethyl, n-propyl, iso-propyl, n-butyl, i-butyl and t-butyl; and

R⁶ is selected from the group consisting of methyl, ethyl, n-propyl, i-propyl, n-butyl,

i-butyl, t-butyl, t-amyl, benzyl, cyclohexyl, 9-anthracenyl, 2-hydroxyethyl, cinnamyl, adamantyl, methyl or ethyl adamantyl, isobornyl, 2-ethoxyethyl, n-heptyl, n-hexyl, 2-hydroxypropyl, 2-ethylbutyl, 2-methoxypropyl, 2-(2-methoxyethoxyl), oxotetrahydrofuran, hydroxytrimethylpropyl, oxo-oxatricyclononyl, 2-naphthyl, 2-phenylethyl, phenyl, and the like.

Suitable acrylate monomers include; MAA—methyl adamantyl acrylate; MAMA—methyl adamantyl methacrylate; EAA—ethyl adamantyl acrylate; EAMA—ethyl adamantyl methacrylate; ETCDA—ethyl tricyclodecanyl acrylate; ETCDMA—ethyl tricyclodecanyl methacrylate; PAMA—propyl adamantyl methacrylate; MBAMA—methoxybutyl adamantyl methacrylate; MBAA—methoxylbutyl adamantyl acrylate; isobornylacrylate; isobornylmethacrylate; cyclohexylacrylate; cyclohexylmethacrylate; 2-methyl-2-adamantyl methacrylate; 2-ethyl-2-adamantyl methacrylate; 3-hydroxy-1-adamantyl methacrylate; 3-hydroxy-1-adamantyl acrylate; 2-methyl-2-adamantyl acrylate; 2-ethyl-2-adamantyl acrylate; 2-hydroxy-1,1,2-trimethylpropyl acrylate; 5-oxo-4-oxatricyclo-non-2-yl acrylate; 2-hydroxy-1,1,2-trimethylpropyl 2-methacrylate; 2-methyl-2-adamantyl 2-methacrylate; 2-ethyl-2-adamantyl 2-methacrylate; 5-oxotetrahydrofuran-3-yl acrylate; 3-hydroxy-1-adamantyl-2-methylacrylate; 5-oxotetrahydrofuran-3-yl 2-methylacrylate; and 5-oxo-4-oxatricyclo-non-2-yl 2 methylacrylate.

Additional acrylates and other monomers that may be used in the present invention with the substituted styrene to form various copolymers include the following materials: monodecyl maleate; 2-hydroxy ethyl methacrylate; isodecyl methacrylate; hydroxy propyl methacrylate; isobutyl methacrylate; lauryl methacrylate; hydroxy propyl acrylate; methyl acrylate; t-butylaminoethyl methacrylate; isocyanatoethyl methacrylate; tributyltin methacrylate; sulfoethyl methacrylate; butyl vinyl ether blocked methacrylic acid; silane; Zonyl TM; Zonyl TA; t-butyl methacrylate; 2-phenoxy ethyl methacrylate; acetoacetoxyethyl methacrylate; 2-phenoxy ethyl acrylate; 2-ethoxy ethoxy ethyl acrylate; β-carboxyethyl acrylate; maleic anhydride; isobornyl methacrylate; isobornyl acrylate; methyl methacrylate; styrene; substituted styrene; ethyl acrylate; 2-ethyl hexyl methacrylate; 2-ethyl hexyl acrylate; glycidyl methacrylate; n-butyl acrylate; acrolein; 2-diethylaminoethyl methacrylate; allyl methacrylate; vinyl oxazoline ester of tall oil; acrylonitrile; methacrylic acid; stearyl methacrylate; meso methacrylate; itaconic acid; acrylic acid; n-butyl methacrylate; ethyl methacrylate; hydroxy ethyl acrylate; and acrylamide.

Suitable RAFT chain transfer agents have a transfer constant in the range of from 0.1 to 500 and include the dithioesters, trithiocarbonates, and xanthates disclosed in, e.g., WO 98 01478 and WO 99 31144, as RAFT chain transfer agents. Typical RAFT agents include compositions represented by Formula IV:

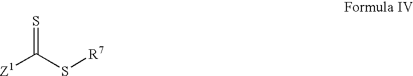

wherein:

R⁷=alkyl, alkenyl, aryl, aralkyl, substituted alkyl, substituted aryl, carbocyclic or heterocyclic ring, alkylthio, alkoxy, or dialkylamino; and

Z¹=H, alkyl, aryl, aralkyl, substituted alkyl, substituted aryl, carbocyclic or heterocyclic ring, alkylthio, arylthio, alkoxycarbonyl, aryloxycarbonyl, carboxy, acyloxy, carbamoyl, cyano, dialkyl- or diaryl-phosphonato, or dialkyl- or diaryl-phosphinato.

In addition, suitable RAFT chain transfer agents include multi-valent compositions represented by Formulas V and VI:

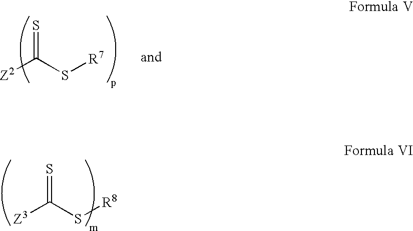

wherein:

Z² is a multi-valent moiety derived from a member of the group consisting of optionally substituted alkyl, optionally substituted aryl and a polymer chain; where the connecting moieties are selected from the group consisting of aliphatic carbon, aromatic carbon, and sulfur;

Z³ is selected from the group consisting of hydrogen, chlorine, optionally substituted alkyl, optionally substituted aryl, optionally substituted heterocyclyl, optionally substituted alkylthio, optionally substituted alkoxycarbonyl, optionally substituted aryloxycarbonyl (—COOR″), carboxy (—COOH), optionally substituted acyloxy (—O₂CR″), optionally substituted carbamoyl (—CONR″₂), cyano (—CN), dialkyl- or diaryl-phosphonato[—P(═O)OR″₂], dialkyl- or diaryl-phosphinato [—P(═O)R″₂], and a polymer chain formed by any mechanism;

R⁷ is defined as above;

R⁸ is a multi-valent moiety derived from a member of the group consisting of optionally substituted alkyl, optionally substituted aryl and a polymer chain; where the connecting moieties are selected from the group consisting of aliphatic carbon, aromatic carbon, and sulfur; and

m and p are integers greater than 1.

Some RAFT chain transfer agents applicable in the process of this invention include:

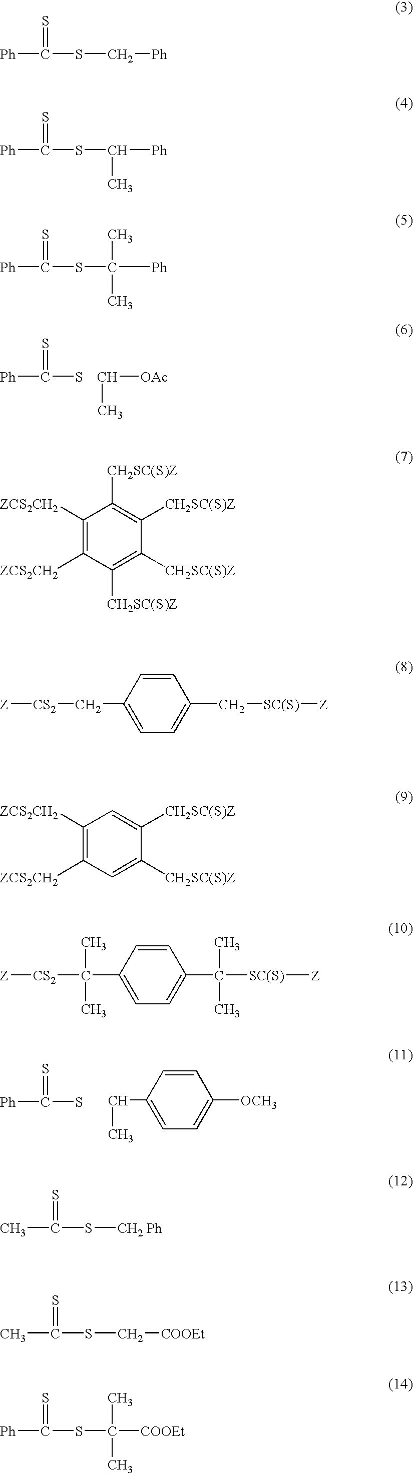

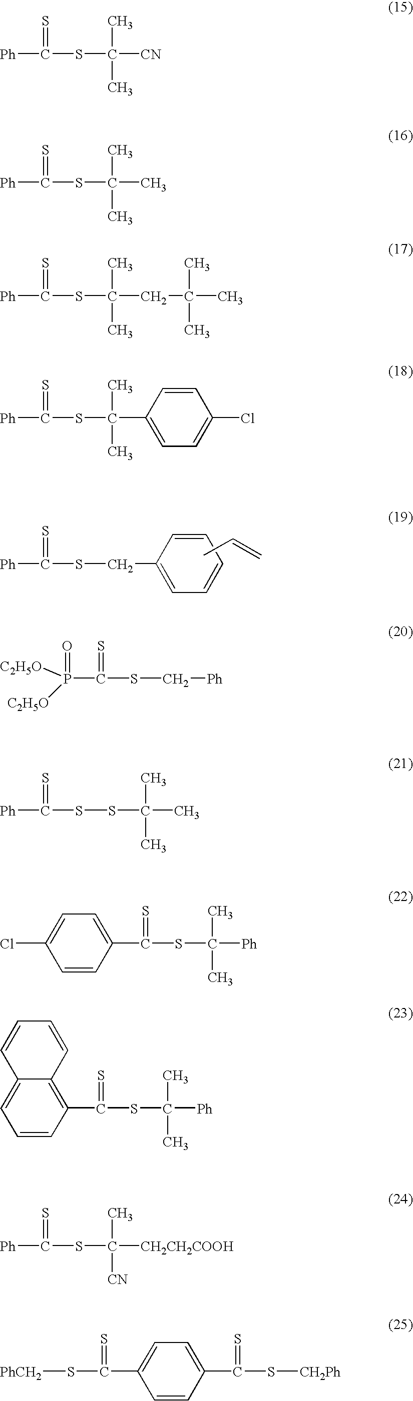

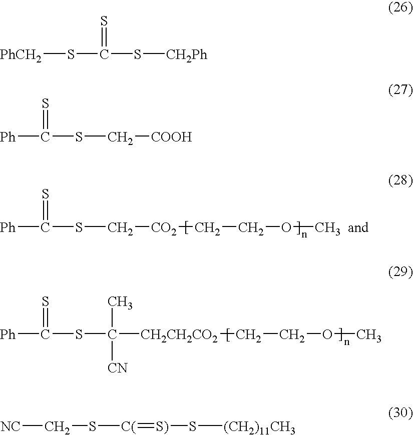

wherein Z is phenyl, and n is 1-22.

A preferred RAFT chain transfer agent is S-cyanomethyl-S-dodecyl trithiocarbonate (CDTC).

Co-polymers having polyhydroxystyrene (PHS) and one or more of the above acrylate monomers are some of the materials that are made by the novel processes of the present invention.

The solvent for this invention is preferably an ester (e.g., PGMEA) or an alcohol having 1 to 4 carbon atoms selected from the group consisting of methanol, ethanol, isopropanol, tert-butanol, 1-methoxy-2-propanol and combinations thereof. The amount of solvent (and/or second solvent) used is not critical and can be any amount that accomplishes the desired end result. In another embodiment in this step 1, the reaction mixture may also comprise an additional co-solvent. The co-solvent is selected from the group consisting of tetrahydrofuran, methyl ethyl ketone, acetone, and 1,4-dioxane.

The free radical initiator may be any initiator that achieves the desired end result. The initiator may be selected from the group consisting of 2,2′-azobis(2,4-dimethylpentanenitrile); 2,2′-azobis(2-methylpropanenitrile); 2,2′-azobis(2-methylbutanenitrile); 1,1′-azobis(cyclohexanecarbo-nitrile); t-butyl peroxy-2-ethylhexanoate; t-butyl peroxypivalate; t-amyl peroxypivalate; di-iso-nonanoyl peroxide; decanoyl peroxide; succinic acid peroxide; di(n-propyl) peroxydicarbonate; di(sec-butyl) peroxydicarbonate; di(2-ethylhexyl) peroxydicarbonate; t-butylperoxyneodecanoate; 2,5-dimethyl-2,5-di(2-ethylhexanoylperoxy)hexane; t-amylperoxyneodecanoate; dimethyl 2,2′-azo-bis-isobutyrate, and combinations thereof.

As a preferred embodiment, the initiator is selected from the group consisting of 1,1-di(t-butylperoxy)-3,3,5-trimethylcyclohexane; 2,2′-azobis(2,4-dimethylpentanenitrile); 2,2′-azobis(2-methylpropanenitrile); 2,2′-azobis(2-methylbutanenitrile); 1,1′-azobis(cyclohexanecarbonitrile); t-butyl peroxy-2-ethylhexanoate; t-butyl peroxypivalate; t-amyl peroxypivalate, and combinations thereof.

The amount of initiator is any amount that accomplishes the desired end result. However, as a preferred embodiment, said initiator is present to about 0.1-0.4 mole percent based upon the total moles of all of said monomers Formulas I, II, III and said copolymerizable monomers.

The amount of RAFT chain transfer agent used depends on the chain-length desired and the conversion. Typically, the amount of chain transfer agent used is 0.1-20 mol %, based on total monomers.

The polymerization conditions are any temperature and pressure that will produce the desired end result. In general, the temperatures are from about 30° C. to about 190° C., preferably from about 40° C. to about 120° C., and most preferably from about 45° C. to about 100° C. The pressure may be atmospheric, sub-atmospheric or super-atmospheric. The polymerization time is not critical, but generally will take place over a period of at least one minute in order to produce a polymer of corresponding composition.

Additional Process Steps

The process of this invention can be further augmented by additional, optional process steps to purify the substituted styrene (co)polymer obtained and/or chemically modify the —OR functional groups of the styrenic repeat unit in the (co)polymer. Some such process steps that are especially useful in preparing (co)polymers for use in photoresists are described below.

Purification

After the polymerization, and prior to chemical modification, the polymer may be subjected to an optional purification procedure wherein a solvent similar to that used in the polymerization process is used to purify the polymer via a multi-step fractionation process.

Alternatively, the (co)polymer can be purified by dissolving it in a suitable solvent, then adding a solvent in which the (co)polymer is not soluble to precipitate out the (co)polymer in preference to the impurities, which are then separated from the (co)polymer by filtration or other means. This purification step may also be carried out one or more times.

Chemical Modification

In one embodiment, a (co)polymer derived from a styrene in which R═C(O)R² is subjected to transesterification conditions in an alcohol solvent in the presence of a catalytic amount of a transesterification catalyst to replace the —OR groups of the styrenic units with —OH. The catalyst is such that it will not substantially react with the polymer, the alkyl acrylate monomer (if present), or with the co-polymerizable monomers (if present). The catalyst is selected from the group consisting of (anhydrous) ammonia, lithium methoxide, lithium ethoxide, lithium isopropoxide, sodium methoxide, sodium ethoxide, sodium isopropoxide, potassium methoxide, potassium ethoxide, potassium isopropoxide, cesium methoxide, cesium ethoxide, cesium isopropoxide, and combinations thereof, wherein the alkoxide anion corresponds to that of the alcohol solvent. It is also to be understood that the catalyst can be an alkali metal hydroxide such as lithium hydroxide, sodium hydroxide, potassium hydroxide, cesium hydroxide or combinations thereof.

In one embodiment, the by-product ester formed can be continually removed from the reaction mixture, for example by carrying out the transesterification at the reflux temperature of the alcohol solvent.

If R=R¹ in the substituted styrene monomer, then the catalyst used to effect the replacement of —OR with OH is a strong acid. Suitable acids include mineral acids such as HCl.

The amount of catalyst employed is generally from about 0.1 mole % to about 2 mole % of the substituted styrene monomer present in the (co)polymer.

In a preferred embodiment, the catalyst is added as a solution in said alcohol solvent.

Purification of the Hydroxy-substituted Styrene (Co)polymer

This optional purification process is carried out prior to catalyst removal.

In one embodiment, the purification is an extraction, in which a solvent that is immiscible with the alcohol solvent is added to an alcoholic solution of the hydroxy-substituted styrene (co)polymer until a second layer is formed. The mixture is then stirred vigorously or is heated to boiling for several minutes and then allowed to stand until cool. A discrete second layer is formed which is then removed by decantation or similar means, and the process is repeated until no further purification is identified, as for example, until a small sample of the decanted (non-alcohol) solvent upon evaporation to dryness shows no residue. In this fashion, there are removed by-products and low weight average molecular weight materials.

The alcoholic solution of the (co)polymer can then be subjected to distillation to remove solvent(s). Azeotropic distillation can be especially useful.

Typical solvents that may be immiscible in alcohol solvents include hexane, heptane, octane, petroleum ether, ligroin, lower alkyl halohydrocarbons, e.g., methylene chloride, and the like.

Catalyst Removal

For many applications of the chemically modified polymers, it is advantageous to purify the hydroxyl-containing (co)polymer of any residual catalyst, for example by contacting a solution of the (co)polymer with an ion-exchange resin.

In one embodiment, a cation-exchange resin, preferably an acidic cation exchange resin, is used. An acidic ion exchange resin, such as sulfonated styrene/divinylbenzene cation exchange resin in hydrogen-form is preferred. Suitable acidic exchange resins are available from Rohm and Haas Company, e.g,. AMBERLYST® 15 acidic ion exchange resin. These Amberlyst® resins typically contain as much as 80,000 to 200,000 ppb of sodium and iron. Before being used in the process of the invention, the ion exchange resin must be treated with water and then a mineral acid solution to reduce the metal ion level. When removing the catalyst from the hydroxyl-containing (co)polymer solution, it is important that the ion exchange resin be rinsed with a solvent that is the same as, or at least compatible with, the polymer solution solvent. The procedure may be similar to those procedures disclosed in U.S. Pat. No. 5,284,930 and U.S. Pat. No. 5,288,850.

Solvent Swap

In another optional process step, the purified hydroxyl-containing (co)polymer is solvent-exchanged with a photoresist compatible or other solvent in which the alcoholic solvent is removed by distillation. This solvent swap method is an all liquid phase process that can be carried out in “one-pot”, and avoids many of the solvent- and solids-handling difficulties encountered in other processes that can be used to replace one solvent with another.

The photoresist compatible solvent is generally selected from the group of glycol ethers, glycol ether acetates and aliphatic esters having no hydroxyl or keto group. Examples include glycol ether acetates such as ethylene glycol monoethyl ether acetate and propylene glycol monomethyl ether acetate (PGMEA), and esters such as ethyl-3-ethoxypropionate and methyl-3-methoxypropionate. PGMEA is preferred. These solvents may be used alone or as a mixture.

Further examples of solvents useful in a solvent swap include butyl acetate, amyl acetate, cyclohexyl acetate, 3-methoxybutyl acetate, methyl ethyl ketone, methyl amyl ketone, cyclohexanone, cyclopentanone, 3-ethoxyethyl propionate, 3-ethoxymethyl propionate, 3-methoxymethyl propionate, methyl acetoacetate, ethyl acetoacetate, diacetone alcohol, methyl pyruvate, ethyl pyruvate, propylene glycol monomethyl ether, propylene glycol monoethyl ether, propylene glycol monomethyl ether propionate, propylene glycol monoethyl ether propionate, ethylene glycol monomethyl ether, ethylene glycol monoethyl ether, diethylene glycol monomethyl ether, diethylene glycol monoethyl ether, 3-methyl-3-methoxybutanol, N-methylpyrrolidone, dimethylsulfoxide, γ-butyrolactone, propylene glycol methyl ether acetate, propylene glycol ethyl ether acetate, propylene glycol propyl ether acetate, methyl lactate, ethyl lactate, propyl lactate, and tetramethylene sulfone. Of these, the propylene glycol alkyl ether acetates and alkyl lactates are especially preferred. The solvents may be used alone or in admixture of two or more.

An exemplary useful solvent mixture is a mixture of a propylene glycol alkyl ether acetate and an alkyl lactate. It is noted that the alkyl groups of the propylene glycol alkyl ether acetates are preferably those of 1 to 4 carbon atoms, for example, methyl, ethyl and propyl, with methyl and ethyl being especially preferred. Since the propylene glycol alkyl ether acetates include 1,2- and 1,3-substituted ones, each includes three isomers depending on the combination of substituted positions, which may be used alone or in admixture. It is also noted that the alkyl groups of the alkyl lactates are preferably those of 1 to 4 carbon atoms, for example, methyl, ethyl and propyl, with methyl and ethyl being especially preferred.

When the propylene glycol alkyl ether acetate is used as the solvent, it preferably accounts for at least 50% by weight of the entire solvent. Also when the alkyl lactate is used as the solvent, it preferably accounts for at least 50% by weight of the entire solvent. When a mixture of propylene glycol alkyl ether acetate and alkyl lactate is used as the solvent, that mixture preferably accounts for at least 50% by weight of the entire solvent. In this solvent mixture, it is further preferred that the propylene glycol alkyl ether acetate is 60 to 95% by weight and the alkyl lactate is 40 to 5% by weight. A lower proportion of the propylene glycol alkyl ether acetate might lead to inefficient coating whereas a higher proportion thereof would provide insufficient dissolution and allow for particle and foreign matter formation. A lower proportion of the alkyl lactate would provide insufficient dissolution and cause the problem of many particles and foreign matter whereas a higher proportion thereof would lead to a composition which has a too high viscosity to be useful in coating applications and loses storage stability.

Usually the solvent is used in amounts of about 300 to 2,000 parts, preferably about 400 to 1,000 parts by weight per 100 parts by weight of the solids in the chemically amplified positive resist composition. The concentration is not limited to this range as long as film formation by existing methods is possible.

Addition Reaction Blocking

The substantially pure hydroxyl-containing (co)polymer can also be subjected to an additional reaction to provide said polymer to protect some or all of the functional/hydroxyl groups with “blocking” groups.

In one embodiment, the hydroxyl-containing (co)polymer is reacted with a vinyl ether compound and/or a dialkyl dicarbonate in the presence of a catalyst in an aprotic solvent. When the (co)polymer is reacted with a vinyl ether, it is done in the presence of an acid catalyst followed by addition of base to neutralize the acid. This is generally called an “acetalization,” wherein an acetal derivatized hydroxyl-containing (co)polymer is formed. Alternatively, reaction of the hydroxyl-containing (co)polymer with a dialkyl dicarbonate in the presence of a base catalyst can be considered an “alcoholysis,” and is also a useful method for introducing “blocking” groups.

The vinyl ethers suitable for use a protective group include those falling within the formula VII

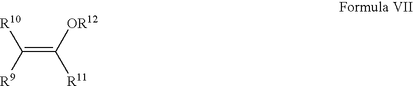

wherein R⁹, R¹⁰ and R¹¹ independently represent a hydrogen atom or a straight-chain, branched, cyclic or heterocyclic alkyl group containing 1 to 6 carbon atoms, and R¹² represents a straight-chain, branched, cyclic or heterocyclic alkyl or aralkyl group containing 1 to 10 carbon atoms which may be substituted with a halogen atom, an alkoxy group, aralkyl oxycarbonyl group, and/or alkyl carbonyl amino group.

The vinyl ether compounds represented by Formula VII include vinyl ethers such as methyl vinyl ether, ethyl vinyl ether, n-butyl vinyl ether, tert-butyl vinyl ether, 2-chloro-ethyl vinyl ether, 1-methoxyethyl vinyl ether, and 1-benzyloxyethyl vinyl ether. Suitable isopropenyl ethers include isopropenyl methyl ether and isopropenyl ethyl ether.

Preferable examples of cyclic vinyl ethers include 3,4-dihydro-2H-pyran, and preferable examples of divinyl ethers include butanediol-1,4-divinyl ether, ethylene glycol divinyl ether, and triethylene glycol divinyl ether.

These vinyl ether compounds can be used alone or in combination. The vinyl ether compounds in total are used preferably in a ratio of 0.1 to 0.7 mol equivalent to the phenolic hydroxyl or carboxyl groups of the alkali-soluble polymer having phenolic hydroxyl or carboxyl groups.

A preferred dialkyl dicarbonate is di-tert-butyl dicarbonate. As with the vinyl ether compounds, the amount of the dialkyl dicarbonate used is preferably 0.1 to 0.7 mol equivalent to the phenolic hydroxyl or carboxyl groups of the alkali-soluble polymer having a phenolic hydroxyl or carboxyl groups.

In the present invention, at least one vinyl ether compound and at least one dialkyl dicarbonate can be used simultaneously for protection of a single alkali-soluble polymer described above.

If the photoresist materials are to be used as a component of a resist composition exposed with, e.g., KrF excimer laser radiation, it is preferable to use a catalyst showing no absorption at 248 nm, i.e., the exposure wavelength of KrF excimer laser. Accordingly, when an acid is used as the reaction catalyst, it is preferred that the acid has no aromatic rings. Examples of acids which can be used as the reaction catalyst in the present invention include: mineral acids such as hydrochloric acid, and sulfuric acid; organic sulfonic acids such as methanesulfonic acid and camphorsulfonic acid; and halocarboxylic acids such as trifluoroacetic acid and trichloroacetic acid. The amount of the acid used is preferably 0.1 to 10 mmol equivalents to the phenolic hydroxyl or carboxyl groups of the polymer having a phenolic hydroxyl or carboxyl groups.

When (+/−) camphorsulfonic acid is used as the reaction catalyst as a solution in propylene glycol monomethyl ether acetate (PGMEA), and the solution is heated or stored for a long period of time, the PGMEA may be hydrolyzed to generate propylene glycol monomethyl ether (PGME), by which the reaction is significantly inhibited. Accordingly, the solution of (+/−)camphorsulfonic acid in PGMEA should be prepared just before use.

Neutralization of the acid catalyst used in the vinyl ether addition reaction improves the storage stability of the (co)polymer. Theoretically, addition of the base in an equivalent amount to the acid is sufficient to inactivate the acid, but because storage stability can be further secured by adding about 10% excess base, addition of about 1.1 equivalents of the base to 1 equivalent of the acid is preferable. This excess base should be taken into consideration in order to determine the amount of another base added as an additive for preparing the resist.

It is also feasible in this neutralization step to use an ion exchange material.

Suitable bases for use in the “blocking” reactions, either as catalysts for the addition of dialkylcarbonates to the hydroxyl-containing (co)polymers or the neutralization of the acid catalyst used in the addition of vinyl ethers, include those that are used as conventional additives in chemically amplified resists. Examples of such bases include: ammonia; organic amines such as triethylamine and dicyclohexyl methylamine; ammonium hydroxides represented by tetramethylammonium hydroxide (TMAH); sulfonium hydroxides represented by triphenylsulfonium hydroxide; iodonium hydroxides represented by diphenyliodonium hydroxide; and conjugated salts of these iodonium hydroxides such as triphenylsulfonium acetate, triphenylsulfonium camphanate, and triphenylsulfonium camphorate. Preferred bases are those which, when formed into a resist composition, do not have influence on resist sensitivity. Optically decomposable bases are preferable. When the amine is present in the resist composition, sensitivity may be lowered. Inorganic bases are not preferable because many of them contain metal ions that contaminate the substrate, e.g., silicon wafers.

Other, radiation-sensitive bases can also be used, including: triphenylsulfonium phenolate; tris-(4-methylphenyl) sulfonium hydroxide; tris-(4-methylphenyl)sulfonium acetate; tris-(4-methylphenyl)sulfonium phenolate; diphenyliodonium acetate; diphenyliodonium phenolate; bis-(4-tert-butylphenyl)iodonium hydroxide; bis-(4-tert-butylphenyl)iodonium acetate; and bis-(4-tert-butylpheny)iodonium phenolate.

Other, non-radiation sensitive bases include: ammonium salts such as tetrabutylammonium hydroxide; amines such as n-hexylamine, dodecylamine, aniline, dimethylaniline, diphenylamine, triphenylamine, diazabicyclooctane, and diazabicycloundecane; and heterocycles such as 3-phenylpyridine, 4-phenylpyridine, lutidine and 2,6-di-tert-butylpyridine.

These base compounds can be used alone or in combination thereof. The amount of the base compound added is determined according to the amount of the photo acid-generating compound and the photo acid-generating ability of the photoacid generator. Usually the base compound is used in a ratio of 10 to 110 mol %, preferably 25 to 95 mole % relative to the amount of the photo acid-generating compound.

Suitable conditions for reacting an alkali-soluble polymer having a phenolic hydroxyl or carboxyl group with a vinyl ether or a dialkyl dicarbonate have been disclosed in the prior art. When a vinyl ether is used to introduce blocking groups, it is preferred that the moisture content is less than about 5,000 ppm, more preferably less than about 1,000 ppm. If larger amounts of water are present, it may be necessary to increase the amount of the vinyl ether compound used. The reaction temperature and reaction time are generally in the range of 0-25° C. and 2-6 hours.

If a single alkali-soluble polymer is protected by both a vinyl ether compound and a dialkyl dicarbonate, usually the polymer is subjected to protection reaction with the vinyl ether compound in the presence of an acid catalyst and then subjected to protection reaction with the dialkyl dicarbonate in the presence of a base catalyst.

The usable base includes radiation-sensitive bases or usual bases not sensitive to radiation. These bases are not necessarily required for resist formulation, but because their addition can prevent the deterioration of pattern characteristics even in the case where the treatment step is conducted with delay, so their addition is preferable. Further, their addition also results in improvements in clear contrast.

Photoacid Generator Addition

A photoresist composition can be prepared without isolating the resist material by directly adding to the resist material solution (prepared as described above) a photoacid generating compound capable of generating an acid upon exposure to actinic radiation (photoacid generator). Other additives can include a base and additives for improvement of optical and mechanical characteristics, film forming properties, adhesion with the substrate, etc. The viscosity of the composition can be adjusted by addition of solvent, if necessary. The solvent used in preparing the resist composition is not necessarily limited to the type of solvent used in the solvent swap, and it is possible to use any other solvent which is conventionally used in preparation of a resist composition. Further, any photo acid-generating compounds and other additives, which are used conventionally in chemically amplified resists, can also be used. The total solid content in the resist composition is preferably in the range of 9 to 50% by weight, more preferably 15 to 25% by weight, relative to the solvent.

The photoacid generator is a compound capable of generating an acid upon exposure to high energy radiation. Preferred photoacid generators are sulfonium salts, iodonium salts, sulfonyldiazomethanes, and N-sulfonyloxyimides. The photoacid generators listed below may be used alone or in admixture of two or more. Several suitable photoacid generators are disclosed in WO 00/66575.

Alternatively, photobase generators (which generate base on exposure to actinic radiation) can be used with suitable (co)polymers.

Sulfonium salts are salts of sulfonium cations with sulfonates. Exemplary sulfonium cations include: triphenylsulfonium; (4-tert-butoxyphenyl)diphenylsulfonium; bis(4-tert-butoxy-phenyl)phenylsulfonium; tris(4-tert-butoxyphenyl)sulfonium; (3-tert-butoxyphenyl)diphenyl-sulfonium; bis(3-tert-butoxyphenyl)phenylsulfonium; tris(3-tert-butoxyphenyl)sulfonium; (3,4-di-tert-butoxyphenyl)diphenylsulfonium; bis(3,4-di-tert-butoxyphenyl)phenylsulfonium; tris(3,4-di-tert-butoxyphenyl)sulfonium; diphenyl(4-thiophenoxyphenyl)sulfonium; (4-tert-butoxycarbonyl-methyloxyphenyl)diphenylsulfonium; tris(4-tert-butoxycarbonylmethyloxyphenyl)sulfonium; (4-tert-butoxyphenyl)bis(4-dimethylaminophenyl)sulfonium; tris(4-dimethylaminophenyl)sulfonium; 2-naphthyldiphenylsulfonium; dimethyl-2-naphthylsulfonium; 4-hydroxyphenyldimethylsulfonium; 4-methoxyphenyl-dimethylsulfonium; trimethylsulfonium; 2-oxocyclohexylcyclohexyl-methylsulfonium; trinaphthylsulfonium; and tribenzylsulfonium. Exemplary sulfonates include: trifluoromethanesulfonate; nonafluorobutanesulfonate; heptadecafluorooctanesulfonate; 2,2,2-trifluorooethanesulfonate; pentafluorobenzenesulfonate; 4-trifluoromethylbenzenesulfonate; 4-fluorobenzenesulfonate; toluenesulfonate; benzenesulfonate; 4,4-toluenesulfonyloxybenzenesulfonate; naphthalenesulfonate; camphorsulfonate; octanesulfonate; dodecylbenzenesulfonate; butanesulfonate; and methanesulfonate. Sulfonium salts based on combination of the foregoing examples are included.

Iodonium salts are salts of iodonium cations with sulfonates. Exemplary iodonium cations include aryliodonium cations such as: diphenyliodonium; bis(4-tert-butylphenyl)iodonium; 4-tert-butoxyphenylphenyliodonium; and 4-methoxyphenylphenyliodonium. Exemplary sulfonates include: trifluoromethanesulfonate; nonafluorobutanesulfonate; heptadecafluorooctanesulfonate; 2,2,2-trifluoroethanesulfonate; pentafluorobenzenesulfonate; 4-trifluoromethylbenzenesulfonate; 4-fluorobenzenesulfonate; toluenesulfonate; benzenesulfonate; 4,4-toluenesulfonyloxy-benzenesulfonate; naphthalenesulfonate; camphorsulfonate; octanesulfonate; dodecylbenzenesulfonate; butanesulfonate; and methanesulfonate. Iodonium salts based on combination of the foregoing examples are included.

Exemplary sulfonyldiazomethane compounds include bis-sulfonyidiazomethane compounds and sulfonylcarbonyldiazomethane compounds such as: bis(ethylsulfonyl)diazo-methane; bis(1-methylpropylsulfonyl)diazomethane; bis(2-methylpropylsulfonyl)diazomethane; bis(1,1-dimethylethylsulfonyl)diazomethane; bis(cyclohexylsulfonyl)diazomethane; bis(perfluoroisopropylsulfonyl)diazomethane; bis(phenylsulfonyl)diazomethane; bis(4-methylphenylsulfonyl)diazomethane; bis(2,4-dimethylphenylsulfonyl)diazomethane; bis(2-naphthylsulfonyl)diazomethane; 4-methylphenylsulfonylbenzoyldiazomethane; tert-butylcarbonyl-4-methylphenylsulfonyidiazomethane; 2-naphthylsulfonylbenzoyldiazomethane; 4-methylphenyl-sulfonyl-2-naphthoyldiazomethane; methylsulfonylbenzoyidiazomethane; and tert-butoxycarbonyl-4-methylphenylsulfonyldiazomethane.

N-sulfonyloxyimide photoacid generators include combinations of imide skeletons with sulfonates. Exemplary imide skeletons include: succinimide; naphthalene dicarboxylic acid imide; phthalimide; cyclohexyldicarboxylic acid imide; 5-norbornene-2,3-dicarboxylic acid imide; and 7-oxabicyclo[2,2,1]-5-heptene-2,3-dicarboxylic acid imide. Exemplary sulfonates include: trifluoromethanesulfonate; nonafluorobutanesulfonate; heptadecafluorooctanesulfonate; 2,2,2-trifluoroethanesulfonate; pentafluorobenzenesulfonate; 4-trifluoromethylbenzenesulfonate; 4-fluorobenzenesulfonate; toluenesulfonate; benzenesulfonate; naphthalenesulfonate; camphorsulfonate; octanesulfonate; dodecylbenzenesulfonate; butanesulfonate; and methanesulfonate,

Benzoinsulfonate photoacid generators include benzoin tosylate, benzoin mesylate, and benzoin butanesulfonate.

Pyrogallol trisulfonate photoacid generators include pyrogallol, fluoroglycine, catechol, resorcinol, hydroquinone, in which all the hydroxyl groups are replaced by trifluoromethanesulfonate, nonafluorobutanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, toluenesulfonate, benzenesulfonate, naphthalenesulfonate, camphorsulfonate, octanesulfonate, dodecylbenzenesulfonate, butanesulfonate, or methanesulfonate.

Nitrobenzyl sulfonate photoacid generators include: 2,4-dinitrobenzyl sulfonate; 2-nitrobenzyl sulfonate; and 2,6-dinitrobenzyl sulfonate. Exemplary sulfonates include: trifluoromethanesulfonate; nonafluorobutanesulfonate; heptadecafluorooctanesulfonate; 2,2,2-trifluoroethanesulfonate; pentafluorobenzenesulfonate; 4-trifluoromethylbenzenesulfonate; 4-fluorobenzenesulfonate; toluenesulfonate; benzenesulfonate; naphthalenesulfonate; camphorsulfonate; octanesulfonate; dodecylbenzenesulfonate; butanesulfonate; and methanesulfonate. Also useful are analogous nitrobenzyl sulfonate compounds in which the nitro group on the benzyl side is replaced by a trifluoromethyl group.

Sulfone photoacid generators include: bis(phenylsulfonyl)methane; bis(4-methylphenylsulfonyl)methane; bis(2-naphthylsulfonyl)methane; 2,2-bis(phenylsulfonyl)propane; 2,2-bis(4-methylphenylsulfonyl)propane; 2,2-bis(2-naphthylsulfonyl)propane; 2-methyl-2-(p-toluenesulfonyl)propiophenone; 2-cyclohexylcarbonyl-2-(p-toluenesulfonyl)propane; and 2,4-dimethyl-2-(p-toluenesulfonyl)pentan-3-one.

Photoacid generators in the form of glyoxime derivatives include: bis-o-(p-toluenesulfonyl)-α-dimethylglyoxime; bis-o-(p-toluenesulfonyl)-α-diphenylglyoxime; bis-o-(p-toluenesulfonyl)-α-dicyclohexylglyoxime; bis-o-(p-toluenesulfonyl)-2,3-pentanedioneglyoxime; bis-o-(p-toluenesulfonyl)-2-methyl-3,4-pentanedioneglyoxime; bis-o-(n-butanesulfonyl)-α-dimethylglyoxime; bis-o-(n-butanesulfonyl)-α-diphenylglyoxime; bis-o-(n-butanesulfonyl)-α-dicyclohexylglyoxime; bis-o-(n-butanesulfonyl)-2,3-pentanedioneglyoxime; bis-o-(n-butanesulfonyl)-2-methyl-3,4-pentanedioneglyoxime; bis-o-(methanesulfonyl)-α-dimethylglyoxime,; bis-o-(trifluoromethanesulfonyl)-α-dimethylglyoxime; bis-o-(1,1,1-trifluoroethanesulfonyl)-α-dimethylglyoxime; bis-o-(tert-butanesulfonyl)-α-dimethylglyoxime; bis-o-(perfluorooctanesulfonyl)-α-dimethylglyoxime; bis-o-(cyclohexylsulfonyl)-α-dimethylglyoxime; bis-o-(benzenesulfonyl)-α-dimethylglyoxime; bis-o-(p-fluorobenzenesulfonyl)-α-dimethylglyoxime; bis-o-(p-tert-butylbenzenesulfonyl)-α-dimethylglyoxime; bis-o-(xylenesulfonyl)-α-dimethylglyoxime; and bis-o-(camphorsulfonyl)-α-dimethylglyoxime.

Of these photoacid generators, the sulfonium salts, bis-sulfonyldiazomethane compounds, and N-sulfonyloxyimide compounds are preferred.

While the anion of the optimum acid to be generated differs depending on the ease of scission of acid labile groups introduced in the polymer, an anion which is nonvolatile and not extremely diffusive is generally chosen. The preferred anions include: benzenesulfonic acid anions; toluenesulfonic acid anions; 4,4-toluenesulfonyloxybenzenesulfonic acid anions; pentafluorobenzenesulfonic acid anions; 2,2,2-trifluoroethanesulfonic acid anions; nonafluorobutanesulfonic acid anions; heptadecafluorooctanesulfonic acid anions; and camphorsulfonic acid anions.

In a chemically-amplified positive resist composition, an appropriate amount of the photoacid generator is 0 to 20 parts, and especially 1 to 10 parts by weight per 100 parts by weight of the solids in the composition. The photoacid generators may be used alone or in a mixture of two or more. The transmittance of the resist film can be controlled by using a photoacid generator having a low transmittance at the exposure wavelength and/or adjusting the amount of the photoacid generator added.

In polymerization process of this invention, and in all subsequent, optional process steps, it is preferred that all reactions be conducted on an anhydrous basis, i.e., wherein the water level is less than about 5,000 parts per million (ppm). This helps avoid possible side reactions and provides a convenient and direct route to a resist compositions without having to isolate the (co)polymer product and then carry out additional processing steps.

Protective Groups for Removal by PAC Catalysis

In addition to the acid-labile groups introduced via reaction of the hydroxyl-containing styrene (co)polymers with vinyl ethers and/or dialkylcarbonates, the (co)polymers of the resist compositions of this invention can contain one or more components having protected acidic fluorinated alcohol groups (e.g., —C(R_{f})(R_{f}′)ORₐ, where Rₐ is not H) or other acid groups that can yield hydrophilic groups by the reaction with acids or bases generated photolytically from photoactive compounds (PACs). A given protected fluorinated alcohol group contains a protecting group that protects the fluorinated alcohol group from exhibiting its acidity while in this protected form. A given protected acid group (Rₐ) is normally chosen on the basis of its being acid-labile, such that when acid is produced upon imagewise exposure, it will catalyze deprotection of the protected acidic fluorinated alcohol groups and production of hydrophilic acid groups that are necessary for development under aqueous conditions.

An alpha-alkoxyalkyl ether group (i.e., Rₐ=OCH₂R_{b}, R_{b}=C₁-C₁₁ alkyl) is a preferred protecting group for the fluoroalcohol group in order to maintain a high degree of transparency in the photoresist composition. An illustrative, but non-limiting, example of an alpha-alkoxyalkyl ether group that is effective as a protecting group, is methoxy methyl ether (MOM). A protected fluoroalcohol with this particular protecting group can be obtained by reaction of chloromethylmethyl ether with the fluoroalcohol. An especially preferred protected fluoroalcohol group has the structure:

—C(R_{f})(R_{f′})O—CH₂OCH₂R₁₅

wherein, R_{f} and R_{f}′ are the same or different fluoroalkyl groups of from 1 to 10 carbon atoms or taken together are (CF₂)ₙ wherein n is 2 to 10; R₁₅ is H, a linear alkyl group of 1 to 10 carbon atoms, or a branched alkyl group of 3 to 10 carbon atoms.

Carbonates formed from a fluorinated alcohol and a tertiary aliphatic alcohol can also be used as protected acidic fluorinated alcohol groups.

The (co)polymers of this invention can also contain other types of protected acidic groups that yield an acidic group upon exposure to acid. Examples of such types of protected acidic groups include, but are not limited to: A) esters capable of forming, or rearranging to, a tertiary cation; B) esters of lactones; C) acetal esters; D) β-cyclic ketone esters; E) α-cyclic ether esters; and F) esters which are easily hydrolyzable because of anchimeric assistance, such as MEEMA (methoxy ethoxy ethyl methacrylate).

Some specific examples in category A) are t-butyl ester, 2-methyl-2-adamantyl ester, and isobornyl ester.

In this invention, often, but not always, the components having protected groups are repeat units having protected acid groups that have been incorporated in the base copolymer resins of the compositions. Frequently the protected acid groups are present in one or more comonomers (e.g., alkyl acrylates and/or EUCMs) that are polymerized with the substituted styrene monomer. Alternatively, acid-functionality introduced via an acid-containing comonomer can be partially or wholly converted by appropriate means to derivatives having protected acid groups.

Dissolution Inhibitors and Additives

Various dissolution inhibitors or enhancers can be added to photoresists derived from the substituted styrene (co)polymers of this invention. Ideally, dissolution inhibitors (DIs) for far and extreme UV resists (e.g., 193 nm resists) should be designed/chosen to satisfy multiple materials needs including dissolution inhibition, plasma etch resistance, and adhesion behavior of resist compositions comprising a given DI additive. Some dissolution inhibiting compounds also serve as plasticizers in resist compositions. Several suitable dissolution inhibitors are disclosed in WO 00/66575.

Positive-Working and Negative-Working Photoresists

The photoresists of this invention can either be positive-working photoresists or negative-working photoresists, depending upon choice of components in the (co)polymer, presence or absence of optional dissolution inhibitor and crosslinking agents, and the choice of developer (solvent used in development). In positive-working photoresists, the resist polymer becomes more soluble and/or dispersible in a solvent used in development in the imaged or irradiated areas whereas in a negative-working photoresist, the resist polymer becomes less soluble and/or dispersible in the imaged or irradiated areas. In one preferred embodiment of this invention, irradiation causes the generation of acid or base by the photoactive component discussed above. The acid or base may catalyze removal of protecting groups. Development in an aqueous base such as tetramethylammonium hydroxide would then result in the formation of a positive image whereas development in an organic solvent or critical fluid (having moderate to low polarity), would result in a negative-working system in which exposed areas remain and unexposed areas are removed. Positive-working photoresists are preferred.

A variety of different crosslinking agents can be employed as required in the negative-working mode of this invention. A crosslinking agent is required in embodiments that involve insolubilization in developer solution as a result of crosslinking, but is optional in preferred embodiments that involve insolubilization in developer solution as a result of polar groups being formed in exposed areas that are insoluble in organic solvents and critical fluids having moderate/low polarity. Suitable crosslinking agents include, but are not limited to, various bis-azides, such as 4,4′-diazidodiphenyl sulfide and 3,3′-diazidodiphenyl sulfone. Preferably, a negative-working resist composition containing a crosslinking agent(s) also contains suitable functionality (e.g., unsaturated C═C bonds) that can react with the reactive species (e.g., nitrenes) that are generated upon exposure to UV to produce crosslinked polymers that are not soluble, dispersed, or substantially swollen in developer solution, that consequently imparts negative-working characteristics to the composition.

Other Components

Photoresists of this invention can contain additional optional components. Examples of optional components include, but are not limited to, resolution enhancers, adhesion promoters, residue reducers, coating aids, plasticizers, surfactants, and T_{g} (glass transition temperature) modifiers.

Imagewise Exposure

The photoresist compositions of this invention are sensitive in the ultraviolet region of the electromagnetic spectrum and especially to those wavelengths ≦365 nm. Imagewise exposure of the resist compositions of this invention can be done at many different UV wavelengths including, but not limited to, 365 nm, 248 nm, 193 nm, 157 nm, and lower wavelengths. Imagewise exposure is preferably done with ultraviolet light of 248 nm, 193 nm, 157 nm, or higher wavelengths, preferably it is done with ultraviolet light of 248 nm, 193 nm, or higher wavelengths, and most preferably, it is done with ultraviolet light of 248 nm or higher wavelengths. Imagewise exposure can either be done digitally with a laser or equivalent device or non-digitally with use of a photomask. Digital imaging with a laser is preferred. Suitable laser devices for digital imaging of the compositions of this invention include, but are not limited to, an argon-fluorine excimer laser with UV output at 193 nm, a krypton-fluorine excimer laser with UV output at 248 nm, and a fluorine (F2) laser with output at 157 nm.

Development

The (co)polymers in the resist compositions of this invention must contain sufficient functionality for development following imagewise exposure to UV light. Preferably, the functionality is acid or protected acid such that aqueous development is possible using a basic developer such as sodium hydroxide solution, potassium hydroxide solution, or ammonium hydroxide solution.

When an aqueous processable photoresist is coated or otherwise applied to a substrate and imagewise exposed to UV light, development of the photoresist composition may require that the binder material contain sufficient acid groups and/or protected acid groups that are at least partially deprotected upon exposure to render the photoresist (or other photoimageable coating composition) processable in aqueous alkaline developer. In case of a positive-working photoresist, the photoresist layer will be removed during development in portions that have been exposed to UV radiation but will be substantially unaffected in unexposed portions. Development of positive-working resists typically consists of treatment by aqueous alkaline systems, such as aqueous solutions containing 0.262 N tetramethylammonium hydroxide, at 25° C. for 2 minutes or less. In case of a negative-working photoresist, the photoresist layer will be removed during development in portions that are unexposed to UV radiation, but will be substantially unaffected in exposed portions. Development of a negative-working resist typically consists of treatment with a critical fluid or an organic solvent.

A critical fluid, as used herein, is a substance heated to a temperature near or above its critical temperature and compressed to a pressure near or above its critical pressure. Critical fluids in this invention are at a temperature that is higher than 15° C. below the critical temperature of the fluid and are at a pressure higher than 5 atmospheres below the critical pressure of the fluid. Carbon dioxide can be used for the critical fluid in the present invention. Various organic solvents can also be used as developer in this invention. These include, but are not limited to, halogenated solvents and non-halogenated solvents. Halogenated solvents are preferred and fluorinated solvents are more preferred. A critical fluid can comprise one or more chemical compounds.

Substrate

The substrate employed in this invention can illustratively be silicon, silicon oxide, silicon oxynitride, silicon nitride, or various other materials used in semiconductive manufacture.

This invention is further illustrated by the following examples that are provided for illustration purposes and in no way limits the scope of the present invention.

### EXAMPLES (GENERAL)

In the Examples that follow, the following abbreviations are used:

ASM—p-Acetoxystyrene monomer

t-BPP—tert-butyl peroxypivalate

THF—Tetrahydrofuran

GPC—Gel permeation chromatography

GC—Gas chromatography

FTIR—Fourier transform infrared spectroscopy

NMR—Nuclear magnetic resonance spectroscopy, usually of either proton, ¹H;

and/or carbon 13, ¹³C nuclei.

DSC—Differential scanning calorimetry

UV-Vis—Ultraviolet-Visible Spectroscopy

General Analytical Techniques Used for the Characterization: A variety of analytical techniques were used to characterize the co- and terpolymers of the present invention that included the following:

NMR: ¹H and ¹³C NMR spectra were recorded on a Bruker 400 MHz spectrometer with 5 mm probes at 400 and 100 MHz, respectively.

GPC: GPC was performed on a Waters gel permeation chromatograph equipped with refractive index detection.

GC: GC analysis was performed on a Hewlett Packard Model 5890 series II gas chromatograph equipped with a DB-1 column.

FTIR: FTIR was recorded on a Mattson Genesis Series FTIR.

DSC: A Perkin Elmer 7700 DSC was used to determine the T_{g} (glass transition temperature) of the co- and terpolymers of this invention. The heating rate was maintained at 10° C./minute, generally, over a temperature range of 50° C. to 400° C. The flow rate of nitrogen or air is maintained at 20 mL/min.

UV-Vis of samples were taken using a Hewlett Packard Vectra 486/33VL UV-Vis spectrophotometer.

### Example 1

### Low Polydispersity Polymers using RAFT Chain Transfer Agents

### Preparation of Homopolymers of 4-hydroxystyrene

Polymerization

To a four neck, 1 liter round bottom flask, fitted with a condenser, mechanical stirrer, nitrogen inlet, and thermowell, 4-acetoxystyrene (ASM) (250.33 g, 1.5204 moles) and 1-methoxy-2-propanol (PGME) (269.4 g) were added. The reactor was heated to 100° C. using a heating mantle and temperature controller. Then, S-cyanomethyl-S-dodecyl trithiocarbonate (CDTC) (2.66 g, 0.83 mmoles) and t-butylperoxyacetate (tBPA) (0.214 g, 75 wt % in OMS, 0.12 mmoles) dissolved in 28.1 g of PGME were added. The reactor was maintained at 100° C. for 24.0 hours. The reactor was then cooled to room temperature. Analysis of the polymer obtained showed a weight average molecular weight of 14,400 and a polydispersity of 1.114 (Table 1).

Isolation

To 546 g of the polymer solution obtained above, 283 g of PGME was added to adjust the concentration of the polymer to 30 wt %. The solid polymer was then isolated by precipitation into methanol (10:1, methanol:polymer solution), filtered through a coarse fit, washed with methanol, and vacuum dried (55° C. 20 torr, 24 hours). 116.5 g of a light yellow solid was obtained.

Deprotection/isolation

To a four neck, 1 liter round bottom flask, fitted with a condenser/Barrett receiver, mechanical stirrer, nitrogen inlet, and thermowell, 111.34 g of the solid obtained above, methanol (218.66 g), and sodium methoxide in methanol (25 wt % in methanol, 1.02 g) were added. The reactor was heated to reflux and was maintained at reflux for 6 hours with continuous take-off of distillate. The distillate was replaced continuously with methanol through out the reaction. The reactor was then cooled to room temperature. The solution obtained was passed through a column of Amberlyst® A15 resin (1″×11″, 10 mL/min) to remove the catalyst. The solid polymer was then isolated by precipitation into water (10:1, water:polymer solution), filtered through a coarse frit, washed with water, and vacuum dried (55° C., 20 torr, 3 days). 75.35 g of a fine white solid was obtained (91.4% yield. 41.3% overall yield). Analysis of the solid gave a weight average molecular weight of 12,820 with a polydispersity of 1.198. Thermal, molecular weight, and optical density information is given in Table 2.

TABLE 1
Conversion and GPC results

| ASM Conversion | | | | GPC | |
|---|---|---|---|---|---|
| | Time | Conc. | | Peak 2 | |
| Sample | (mins) | (wt %) | Conversion | Mw | PD |
| 1a | 0.0 | 45.00 | 0.00% | 152 | |
| 1b | 118 | 43.93 | 2.38% | 3,388 | 1.200 |
| 1c | 1060 | 28.72 | 36.18% | 12,264 | 1.122 |
| 1d | 1443 | 24.89 | 44.69% | 14,400 | 1.114 |

TABLE 2
Analysis of Deprotected Polymer

| Parameter | Result |
|---|---|
| UV Transparency | 143 L/M cm |
| T_{g} | 176.5° C. |
| M_{w} | 12,820 |
| Mₙ | 10,699 |
| Polydispersity | 1.198 |

### Example 2

### Homopolymers of 4-acetoxystyrene

Polymerization

To a four neck, 1 liter round bottom flask, fitted with a condenser, mechanical stirrer, nitrogen inlet, and thermowell, 4-acetoxystyrene (ASM) (250.56 g, 1.5205 moles) and 1-methoxy-2-propanol (PGME) (273.5 g) were added. The reactor was heated to 100° C. using a heating mantle and temperature controller. Then, S-cyanomethyl-S-dodecyl trithiocarbonate (CDTC) (2.63 g, 0.83 mmoles) and 1,1-di(t-butylperoxy)-3,3,5-trimethylcyclohexane (TMCH) (0.56 g, 0.18 mmoles) dissolved in 20.7 g of PGME were added. The reactor was maintained at 100° C. for 26.4 hours. The reactor was then cooled to room temperature. Analysis of the polymer solution obtained showed a weight average molecular weight of 23,036 and a polydispersity of 1.294 (Table 3). Conversion of ASM to polymer was analyzed by gas chromatography and determined to be 83.12%.

TABLE 3
Conversion and GPC results for 4-Acetoxystyrene
Homopolymer of Example 2

| ASM Conversion | | | | Molecular | |
|---|---|---|---|---|---|
| | Time | Conc. | | Weight | |
| Sample | (mins) | (wt %) | Conversion | Mw | PD |
| | 0.0 | 45.00 | 0.00% | 152 | |
| 2a | 185 | 26.72 | 40.63% | 11,017 | 1.180 |
| 2b | 1100 | 9.23 | 79.49% | 21,905 | 1.418 |
| 2c | 1580 | 7.60 | 83.12% | 23,036 | 1.294 |

### Example 3

### Copolymer of 4-hydroxystyrene and styrene

Polymerization

To a four neck, 1 liter round bottom flask, fitted with a condenser, mechanical stirrer, nitrogen inlet, and thermowell, 4-acetoxystyrene (ASM) (212.50 g, 1.29 moles), styrene (23.86 g, 0.23 moles), propylene glycol methyl ether acetate (PGMEA) (273.09 g), S-cyanomethyl-S-dodecyl trithiocarbonate (CDTC) (7.05 g, 2.22 mmoles), and 1,1-di(t-butylperoxy)-3,3,5-trimethylcyclohexane (TMCH) (1.46 g, 0.48 mmoles) were added. The reactor was heated to 100° C. using a heating mantle and temperature controller. The reactor was maintained at 100° C. for 25.8 hours. The reactor was then cooled to room temperature. Analysis of the polymer obtained showed a weight average molecular weight of 10,782 and a polydispersity of 1.205 (Table 4). Conversion of ASM was 98.02% and styrene 95.43%.

Purification

The above product was purified using reverse precipitation using methanol as a non-solvent. To the stirred reactor, methanol was slowly added (351.0 g) until a thick solid was formed. The stirrer was stopped and the solids were allowed to settle for a period of 30 minutes. Then, 418.8 g of the top solution layer was removed by suction. To the resulting solids, PGMEA (67.9.1 g) was added and the mixture was stirred until the solids were completely dissolved. Again, to the stirred reactor, methanol was slowly added (190.9 g) until a thick solid was formed. The stirrer was stopped and the solids were allowed to settle for a period of 30 minutes. Then, 221.2 g of the top solution layer was removed by suction. To the resulting solids, PGMEA (87.2 g) was added and the mixture was stirred until the solids were completely dissolved. Finally, to the stirred reactor, methanol was slowly added (174.4 g) until a thick solid was formed. The stirrer was stopped and the solids were allowed to settle for a period of 30 minutes. Then, 344.5 g of the top solution layer was removed by suction. To the resulting solids, methanol (326.1 g) was added to adjust the solids content to 30 wt %.

Deprotection/isolation

To the above reactor, fitted with a condenser/Barrett receiver, mechanical stirrer, nitrogen inlet, and thermowell, sodium methoxide in methanol (25 wt % in methanol, 1.98 g) was added. The reaction mixture was heated to reflux and was maintained at reflux for 4.3 hours with continuous take-off of distillate. The distillate was replaced to the reactor continuously with methanol throughout the reaction. The reactor was then cooled to room temperature. The solution obtained was passed through a column of Amberlyst® A15 resin (1″×11″, 8 mL/mm) to remove the catalyst. The solid polymer was then isolated by precipitation into water (10:1. water:polymer solution), filtered through a coarse frit, washed with water, and vacuum dried (55° C., 20 torr, 3 days). 159.9 g of a fine white solid was obtained (88.2% overall yield). Analysis of the solid gave a weight average molecular weight of 10,051 with a polydispersity of 1.210.

TABLE 4
Conversion and GPC results for Hydroxy-styrene/Styrene
Copolymer
ASM:Styrene Conversion

| | | ASM | | Styrene | | | |
|---|---|---|---|---|---|---|---|
| | | Conc. | | Conc. | | GPC | |
| Sample | Time (mins) | (wt %) | Conversion | (wt %) | Conversion | Mw | PD |
| | 0.0 | 40.42 | 0.00% | 4.60 | 0.00% | 152 | |
| 3a | 76 | 24.81 | 38.62% | 4.09 | 11.09% | 3,552 | 1.157 |
| 3b | 236 | 10.82 | 73.23% | 2.54 | 44.78% | 6,892 | 1.156 |
| 3c | 1227 | 0.85 | 97.90% | 0.23 | 95.00% | 10.626 | 1.204 |
| 3d | 1529 | 0.80 | 98.02% | 0.21 | 95.43% | 10,782 | 1.205 |

While specific reaction conditions, reactants, and equipment are described above to enable one skilled in the art to practice the invention, one skilled in the art will be able to make modifications and adjustments that are obvious extensions of the present inventions. Such obvious extensions of or equivalents to the present invention are intended to be within the scope of the present inventions, as demonstrated by the claims that follow.

What is claimed is:

1. A process comprising polymerizing a substituted styrene monomer alone or in combination with one or more monomers selected from the group consisting of alkyl acrylates and ethylenically unsaturated co-polymerizable monomers in the presence of a solvent, a RAFT chain transfer agent and an initiator, to form a reaction mixture A comprising a substituted styrene (co)polymer.

2. The process of claim 1, wherein the reaction mixture A comprises a solid portion, and the process further comprises washing the solid portion with a first solvent to remove readily soluble impurities.

3. The process of claim 1, wherein the substituted styrene monomer is represented by Formula I 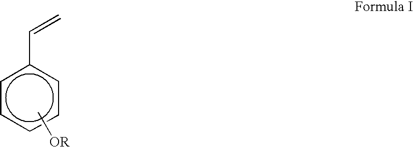
wherein R is R¹ or C(O)R²; and
R¹ and R² are independently H, C₁-C₅ alkyl, either straight chain or branched; and the aromatic ring may be further substituted with functional groups such as halo, alkyl, substituted alkyl, aryl and substituted aryl groups.

4. The process of claim 3, further comprising reacting the substituted styrene (co)polymer with an alcohol and a catalyst to provide reaction mixture B comprising hydroxyl-substituted styrene (co)polymer.

5. The process of claim 4, further comprising extracting dissolved by-products and low weight average molecular weight polymers from reaction mixture B.

6. The process of claim 4, further comprising removing the catalyst.

7. The process of claim 6, wherein the catalyst is removed by contacting reaction mixture B with an ion exchange resin.

8. The process of claim 6, further comprising exchanging the first solvent for a second solvent.

9. The process of claim 1, wherein the polymerization temperature is from about 30° C. to about 190° C.

10. The process of claim 3, wherein the substituted styrene comprises para-acetoxystyrene, and reaction mixture A comprises a para-acetoxystyrene (co)polymer.

11. The process of claim 4, further comprising reacting the hydroxyl-substituted styrene (co)polymer
with a vinyl ether in the presence of an acid catalyst to form an acetal derivatized polymer.

12. The process of claim 11, further comprising a neutralization step.

13. The process of claim 12, further comprising adding a photoacid generator.

14. The process of claim 4, further comprising reacting the hydroxyl-substituted styrene (co)polymer with an anhydride in the presence of an aromatic base to produce a substituted styrene (co)polymer which also contains acid labile groups pendent thereto.

15. The process of claim 14, wherein the anhydride is selected from the group consisting t-butyl esters, t-butyl carbonates, and mixtures thereof.

16. The process of claim 1, wherein the RAFT chain transfer agent is selected from the group of compositions represented by Formula IV, V or VI: 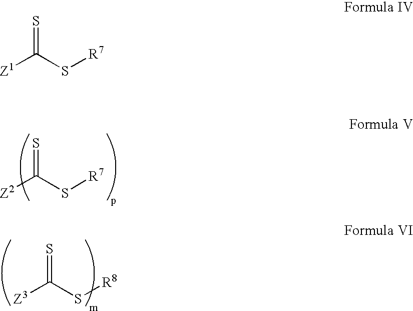
wherein:
R⁷ is alkyl, alkenyl, aryl, aralkyl, substituted alkyl, substituted aryl, carbocyclic or heterocyclic ring, alkylthio, alkoxy, or dialkylamino; and
Z¹ is H, alkyl, aryl, aralkyl, substituted alkyl, substituted aryl, carbocyclic or heterocyclic ring, alkylthio, arylthio, alkoxycarbonyl, aryloxycarbonyl, carboxy, acyloxy, carbamoyl, cyano, dialkyl- or diaryl-phosphonato, or dialkyl- or diaryl-phosphinato;
Z² is a multi-valent moiety derived from a member of the group consisting of optionally substituted alkyl, optionally substituted aryl and a polymer chain; where the connecting moieties are selected from the group consisting of aliphatic carbon, aromatic carbon, and sulfur;
Z³ is selected from the group consisting of hydrogen, chlorine, optionally substituted alkyl, optionally substituted aryl, optionally substituted heterocyclyl, optionally substituted alkylthio, optionally substituted alkoxycarbonyl, optionally substituted aryloxycarbonyl (—COOR″), carboxy
(—COOH), optionally substituted acyloxy (—O₂CR″), optionally substituted carbamoyl (—CONR″₂), cyano (—CN), dialkyl- or diaryl-phosphonato [—P(═O)OR″₂], dialkyl- or diaryl-phosphinato
[—P(═O)R″₂], and a polymer chain formed by any mechanism;
R⁸ is a multi-valent moiety derived from a member of the group consisting of optionally substituted alkyl, optionally substituted aryl and a polymer chain; where the connecting moieties are selected from the group consisting of aliphatic carbon, aromatic carbon, and sulfur; and
m and p are integers greater than 1.

17. The process of claim 16, wherein the RAFT chain transfer agent is S-cyanomethyl-S-dodecyl trithiocarbonate.

18. A substituted styrene (co)polymer produced by the process of claim 1, 4, 11, or 14 with a polydispersity less than about 2.

19. The substituted styrene (co)polymer of claim 16, wherein the polydispersity is less than about 1.3.

20. A photoresist composition comprising the substituted styrene (co)polymer produced by the process of claim 1, claim 11, claim 14 or claim 18.

21. The photoresist composition of claim 20, further comprising a dissolution inhibitor and/or a photoacid generator.

22. The photoresist composition of claim 20, further comprising a solvent.

23. A process for preparing a photoresist image on a substrate comprising:
(A) applying a coatable photoresist composition on a substrate, wherein the coatable photoresist composition comprises:
(1.) a substituted styrene (co)polymer produced by the process of claim 1, claim 11, claim 14 or claim 18;
(2.) a photoactive component; and
(3.) a solvent;
(B) drying the coatable photoresist composition to substantially remove the solvent to form a photoresist layer on the substrate;
(C) imagewise exposing the photoresist layer to form imaged and non-imaged areas; and
(D) developing the exposed photoresist layer having imaged and non-imaged areas to form a relief image on the substrate.

24. An article of manufacture comprising a substrate coated with a photoresist composition of claim 20.

25. A liquid phase process for preparing a photoresist composition containing polymer in solution and which polymer has a low polydispersity and which comprises the steps of:
(A) polymerizing, in the presence of a thiocarbonylthio chain transfer agent, a substituted styrene monomer alone or in combination with a monomer or monomers selected from the group consisting of alkyl acrylates, ethylenically unsaturated co-polymerizable monomer or monomers and mixtures thereof, in a first solvent in the presence of an initiator for a sufficient period of time and at a sufficient temperature and pressure to form a polymer and first solvent mixture;
(B) purifying the polymer and first solvent mixture by fractionation wherein additional first solvent is added to said mixture, said mixture is heated and/or stirred, the mixture is allowed to settle, the first solvent is decanted, and further first solvent is added, and repeating this fractionation at least once more;
(C) transesterifying said purified mixture of step (B) wherein said mixture is refluxed at the boiling point of said first solvent in the presence of a catalyst for a sufficient period of time and at a sufficient temperature and pressure to form a reaction mixture containing a hydroxyl containing polymer and first solvent;
(D) purifying said reaction mixture from step (C) wherein a second solvent is mixed with said reaction mixture in which said second solvent is immiscible, allowing the layers to separate, and removing said second solvent and any dissolved by-products and low weight average molecular weight polymers dissolved therein;
(E) passing said purified reaction mixture of step (D) through an ion exchange material in order to remove any catalyst therefrom and thus provide a substantially catalyst-free hydroxyl containing polymer solution;
(F) adding a third solvent, which is photoresist compatible, to said polymer solution from step (E) and then distilling off the first solvent at a temperature of at least the boiling point of said first solvent for a sufficient period of time in order to remove substantially all of said first solvent to provide a substantially pure polymer in solution in said third solvent.

26. A liquid phase process for preparing a substantially anhydrous and pure polymer and which comprises the steps of:
(A) polymerizing one or more substituted styrenes in combination with a thiocarbonylthio compound in a solvent in the presence of an initiator for a sufficient period of time and at a sufficient temperature and pressure to form a poly(substituted styrene) and solvent mixture;
(B) transesterifying said mixture of step (A) wherein said mixture is refluxed at the boiling point of said solvent in the presence of a catalyst for a sufficient period of time and at a sufficient temperature and pressure to form a reaction mixture containing a polymer and solvent;
(C) passing said reaction mixture of step (B) through an ion exchange material in to remove any catalyst therefrom and thus provide a substantially catalyst-free polymer solution;
(D) adding a second solvent to said polymer solution from step (C) and then distilling off the first solvent at a temperature of at least the boiling point of said first solvent for s sufficient period of time in order to remove substantially all of said first solvent to provide a substantially pure polymer in solution in said second solvent.

27. A liquid phase process for preparing an anhydrous and pure polyhydroxystyrene and which comprises the steps of:
(A) polymerizing a substituted acetoxystyrene in combination with a thiocarbonylthio compound in a solvent in the presence of an initiator for a sufficient period of time and at a sufficient temperature and pressure to form a polysubstituted acetoxy styrene and solvent mixture;
(B) purifying the polysubstituted acetoxystyrene and solvent mixture by fractionation wherein additional solvent is added to said mixture, the mixture is allowed to settle, the solvent is decanted, and further solvent is added, and repeating this fractionation at least once more;
(C) transesterifying said purified mixture of step (B) wherein said mixture is refluxed at the boiling point of said solvent in the presence of a catalyst for a sufficient period of time and at a sufficient temperature and pressure to form a reaction mixture containing polyhydroxystyrene and solvent;
(D) passing said reaction mixture of step (C) through an ion exchange material in to remove any catalyst therefrom and thus provide a substantially catalyst-free polyhydroxystyrene solution;
(E) adding a second solvent to said polyhydroxystyrene solution from step (D) and then distilling off the first solvent at a temperature of at least the boiling point of said first solvent for a sufficient period of time in order to remove substantially all of said first solvent to provide a substantially pure polyhydroxystyrene in solution in said second solvent.
